(19) United States
(12) Patent Application Publication
(10) Pub. No.: US 2026/0089296 A1
(43) Pub. Date: Mar. 26, 2026

(54) Projection System and Methods Therefor

(71) Applicant: The Invisible Pixel Inc., San Diego, CA (US)

(72) Inventor: Kevin Walter Ryniker, San Diego, CA (US)

(73) Assignee: The Invisible Pixel Inc., San Diego, CA (US)

(21) Appl. No.: 19/406,848

(22) Filed: Dec. 2, 2025

Related U.S. Application Data
(63) Continuation-in-part of application No. 18/084,738, filed on Dec. 20, 2022, now Pat. No. 12,510,814.
(60) Provisional application No. 63/293,418, filed on Dec. 23, 2021.

(51) Int. Cl. H04N 9/31; G03B 21/00; G03B 21/62; G06T 7/73

(52) U.S. Cl. CPC H04N 9/3129; G03B 21/008; G03B 21/62; G06T 7/73; H04N 9/3135; H04N 9/3155; H04N 9/3164; G06T 2207/10064; G06T 2207/30204

(57) ABSTRACT

Various methods and systems for producing an animated video effect are provided. One method includes producing a grayscale representation and optionally an alpha channel of the desired video effect, wherein the video effect is visible in a visible light spectrum. A projector then projects, in an ultraviolet light spectrum, the alpha channel/gray scale representation of the video effect onto a projection surface, wherein the projection surface comprises an arrangement of different fluorescent pigments in respective fixed positions, each fluorescent pigment having respective and distinct fluorescence emission in the visible light spectrum when excited by light in the ultraviolet light spectrum, and wherein the different fluorescent pigments are arranged on the surface such that projection of the alpha channel/gray scale representation of the video effect in the ultraviolet light spectrum generates a visible representation of the animated and colored video effect from the respective and distinct fluorescence emissions.

This application is a continuation-in-part application of allowed U.S. patent application with the Ser. No. 18/084,738, filed Dec. 20, 2022, which claims priority to U.S. Provisional patent application with the Ser. No. 63/293,418, filed Dec. 23, 2021, both of which are incorporated by reference herein.

### FIELD OF THE INVENTION

The field of the invention is direct to projecting an image on a projection surface using at least one ultraviolet light source to excite fluorescent material associated with the surface to form images.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Projection displays today are designed to directly produce images in red, green and blue colors of visible light and then project the visible light on a projection surface, such as a screen, to show the images on the screen. In such systems, the screen is simply a surface that receives the visible light and thus renders the images visible to a viewer. Such projection displays may use white light sources where white beams are filtered and modulated to produce images in red, green and blue colors of visible light. Alternatively, three visible light sources in red, green and blue may be used to directly produce three beams in red, green and blue colors of visible light and the three beams are modulated to produce the images. Examples of such projection displays include digital light processing (DLP) displays, liquid crystal on silicon (LCoS) displays, and grating light valve (GLV) displays. Notably, GLV displays use three grating light valves to modulate red, green and blue laser beams, respectively, and use a beam scanner to produce the images on a screen. Another example of laser-based projection displays is described in U.S. Pat. No. 5,920,361. Projection displays use optical lens systems to project the images on the screen. However, conventional projection displays suffer from limited brightness, especially when the projection displays are in the presence of daylight. Furthermore, conventional projection displays cannot project on transparent surfaces and thus are not suitable for holographic or animatronic applications. Moreover, due to the need to project the visible light to the screen, conventional projection displays exhibit poor black levels due to their inability to prevent illumination of portions of the screen that should appear black.

Some other image and video displays use a “direct” configuration where the screen itself includes visible light-producing color pixels to directly form images in the screen. Such direct displays eliminate the optical lens systems for projecting the images and therefore can be made relatively smaller than projection displays with the same screen sizes. Examples of direct display systems include plasma displays, liquid crystal displays (LCDs), light-emitting-diode (LED) displays (e.g., organic LED displays), and field-emission displays (FEDs). Each color pixel in such direct displays includes three adjacent color pixels which visible light in red, green and blue, respectively, by either directly emit colored light as in LED displays and FEDs or by filtering white light such as the LCDs. However, direct displays at sizes necessary for cinema environments or movie production are cost prohibitive for most users. Furthermore, similar to conventional projection displays, direct displays cannot project on transparent surfaces and thus are also not suitable for holographic or animatronic applications. Moreover, today's displays, with the exception of organic LED displays, require the use of a backlight to illuminate their visible light-producing color pixels and thus also exhibit poor black levels.

In view of these deficiencies, digital projectors have been developed that can create images in glass by projecting ultraviolet light generated by ultraviolet light sources to excite fluorescent materials integrated into the glass (see U.S. Pat. No. 6,986,581). The fluorescent materials emit visible light in response to absorption of ultraviolet light generated by the digital projector to form the image on the glass. The digital projectors include scanning units for selectively illuminating the desired fluorescent materials with ultraviolet light to excite the fluorescent materials according to the desired images. However, due to the independent lighting of each of colors of the fluorescent materials, the resulting images by these digital projectors lack brightness during bright scenes due to the emission constraints of each ultraviolet light source on its own. Furthermore, these digital projectors are not suitable for holographic or animatronic applications due to the limitations of using glass for its projection surface.

Thus, even though various devices and methods of for projecting an image on a projection surface are known in the art, all or almost all of them suffer from several drawbacks. Therefore, there remains a need for devices and methods for projecting an image on a projection surface.

### SUMMARY OF THE INVENTION

The inventive subject matter is directed to various devices and methods for projecting an image on a projection surface using at least one ultraviolet light source to excite fluorescent material deposited on the surface to form images. The at least one ultraviolet light source may generate a single wavelength of ultraviolet light capable of exciting the fluorescent material to emit a color (e.g., red, green, blue, yellow, etc.). Alternatively, the at least one ultraviolet light source may generate a plurality of wavelengths of ultraviolet light capable of exciting a plurality of fluorescent materials to emit a variety of colors.

In one aspect of the inventive subject matter, the inventors contemplate a digital projector. The digital projector includes a control circuit configured to receive a video signal from a video source and to convert the video signal to a 4-channel signal. The 4-channel signal includes a red channel signal, a green channel signal, a blue channel signal, and a luminance signal. The digital projector further includes a first, second, third, and fourth ultraviolet light source with each electronically coupled to the control circuit.

It is contemplated that the first ultraviolet light source emits ultraviolet light in a first wavelength band, the second ultraviolet light source emits ultraviolet light in a second wavelength band, and the third ultraviolet light source emits ultraviolet light in a third wavelength band. The first, second, and third wavelength bands do not substantially overlap. The fourth ultraviolet light source emits ultraviolet light in a fourth wavelength band that overlaps with the first, second, and third wavelength bands. The inventor contemplates that the fourth ultraviolet light source may be utilized to increase luminance of the image on the projection surface based on the luminance signal.

Typically, the digital projector further includes first, second, third, and fourth scanning unit coupled to the first, second, third, and fourth ultraviolet light sources, respectively. The scanning units are further electronically coupled to the control circuit. The control circuit uses the 4-channel signal to control operation of the first, second, third, and fourth scanning units.

It is contemplated that the digital projector further includes a light assembly that includes one of the ultraviolet light sources and the corresponding scanning unit. In these and other embodiments, the ultraviolet light sources include an ultraviolet diode and the scanning units include a liquid crystal display (LCD) chip, a digital micro mirror (DMD), a galvanometer-based scanning motor, or combinations thereof. In exemplary embodiments, the scanning units include the liquid crystal display (LCD) chip. In various embodiments, the light assembly includes a filter (e.g., a bandpass filter), a lens (e.g., a collimating lens, a condenser lens, and/or a focus/zoom lens).

In another aspect of the inventive subject matter, the inventor contemplates a projection surface including a carrier substrate to which are coupled a first, second, and third fluorescent materials. The first fluorescent material emits fluorescence at a first color (e.g., red) when illuminated by ultraviolet light in a first wavelength band. The second fluorescent material emits fluorescence at a second color (e.g., green) when illuminated by ultraviolet light in a second wavelength band. The third fluorescent material emits fluorescence at a third color (e.g., blue) when illuminated by ultraviolet light in a third wavelength band. The first, second, and third colors are distinct and the first, second, and third wavelength bands do not substantially overlap. The first, second, and third fluorescent materials are arranged in a pixel pattern.

It is contemplated that the fluorescent materials are substantially transparent. In various embodiments, the fluorescent materials include a fluorescent component (e.g., a fluorophore, a fluorescent energy transfer dye, a fluorescent pigment, a fluorescent polymer, and/or a fluorescent protein) and a fluorescent carrier (e.g., epoxy, acetate and/or polyethylene).

In various embodiments, the carrier substrate includes a plastic, a glass, or a combination thereof. The projection surface may include a coating layer overlying the carrier substrate. It is also contemplated that the carrier substrate and the coating layer are substantially transparent. The coating layer may include polycarbonate, polyurethane, silicone, PET, polyethylene, or combinations thereof.

It is contemplated that the projection surface may further include a photochromatic compound disposed between the carrier substrate and the fluorescent materials that is capable of decreasing the transmittance of visible light therethrough in the presence of a stimuli. In contrast, the photochromatic compound is substantially transparent in the absence of the stimuli. The projection surface may further include one or more additives, such as an ultraviolet absorber, an adhesive, a filler, or combinations thereof.

In a different aspect of the invention, the inventor contemplates a method of producing an animated and colored video effect on a surface involving the step of obtaining or producing an alpha channel/gray scale representation of the animated and colored video effect, wherein the animated and colored video effect is visible in a visible light spectrum. This method further involves projecting, by a projector having an ultraviolet light source, in an ultraviolet light spectrum the alpha channel/gray scale representation of the video effect onto a projection surface. Typically, the projection surface comprises an arrangement of different fluorescent pigments in respective fixed positions, each fluorescent pigment having respective and distinct fluorescence emission in the visible light spectrum when excited by light in the ultraviolet light spectrum. Further, the different fluorescent pigments are arranged on the surface such that projection of the alpha channel/gray scale representation of the video effect in the ultraviolet light spectrum generates a visible representation of the animated and colored video effect from the respective and distinct fluorescence emissions.

It is contemplated that the ultraviolet light spectrum is a UV-A spectrum.

It is additionally contemplated that the different fluorescent pigments are at least 10 different fluorescent pigments.

In various embodiments, at least two different fluorescent pigments are located in the same fixed position to thereby generate a fluorescence emission that is different from a fluorescence emission of the at least two different fluorescent pigments individually.

In another aspect of the contemplated subject matter, the arrangement of the different fluorescent pigments in the respective fixed positions produces a color gradient when illuminated by the ultraviolet light spectrum across the fixed positions.

For some embodiments, the visible representation of the animated and colored video effect has substantially the same color palette as the animated and colored video effect from which the alpha channel/gray scale representation was made.

Typically, but not always, the projection surface is transparent.

In one aspect of the inventive subject matter, the method further involves the step of projecting, in a second and distinct ultraviolet light spectrum a second and distinct alpha channel/gray scale representation of a second and distinct video effect onto the projection surface. Typically, the projection surface comprises a second and distinct arrangement of different fluorescent pigments in respective fixed positions, each fluorescent pigment having respective and distinct fluorescence emission in the visible light spectrum only when excited by light in the second and distinct ultraviolet light spectrum.

It should also be appreciated that the second and distinct alpha channel/gray scale representation of a second and distinct video effect may be projected onto the projection surface by the same projector.

The inventor contemplates that the second and distinct arrangement of different fluorescent pigments may comprise fluorescent pigments that emit fluorescence within a range of between 450 nm and 720 nm.

In another aspect of the inventive subject matter, the inventor contemplates a method of producing an animated and monochromatic video effect on a surface. This process involves obtaining or producing a gray scale representation of the animated and monochromatic video effect, wherein the animated and monochromatic video effect is visible in a visible light spectrum, and then projecting, by a projector having an ultraviolet light source, in an ultraviolet light spectrum the gray scale representation of the video effect onto a projection surface. This projection surface is typically covered with a continuous layer of a fluorescent pigment having a fluorescence emission in the visible light spectrum when excited by light in the ultraviolet light spectrum. The layer typically produces in response to projection of the gray scale representation of the video effect in the ultraviolet light spectrum a visible representation of the animated and monochromatic video effect from the fluorescence emission.

The projection surface may, in some aspects, comprise an opaque surface.

The inventor contemplates that the visible representation of the animated and monochromatic video effect from the fluorescence emission may have a single color within a range of between 450 nm and 720 nm.

The inventor also contemplates that, in some embodiments, the visible representation of the animated and monochromatic video effect from the fluorescence emission has a white color. Optionally, this method may further comprise a step of projecting a representation of the video effect in a visible light spectrum onto the projection surface such that the visible representation of the animated and monochromatic video effect from the fluorescence emission and the representation of the video effect in the visible light spectrum are registered.

In yet another aspect of the inventive subject matter, the inventor contemplates a single waveband scanline red-green-blue (RGB) display system. This single waveband scanline system typically includes a projection surface comprising a plurality of line triplets, each line triplet comprising a first line comprising a first fluorescent dye that emits fluorescence in a red light, a second line comprising a second fluorescent dye that emits fluorescence in a green light, and a third line comprising a third fluorescent dye that emits fluorescence in a blue light. The system also typically includes a projector comprising a controller operationally coupled to a digital micromirror device (DMD) chip, and an ultraviolet light source optically coupled to the DMD chip/The controller is configured to receive video data comprising a plurality of frames, each frame containing a plurality of pixels, and each pixel having RGB information. The controller is programmed to cause the DMD chip to project ultraviolet light onto the first, second, and third line, one at a time per frame. Typically, the controller is also programmed to illuminate only portions of the first, second, and third line in which corresponding pixels in the frame have red, green, and/or blue color.

In some aspects, the projection surface further comprises a plurality of fiduciary markers, wherein the projector further comprises a camera that is configured to acquire a fluorescence signal from the fiduciary markers.

In other aspects, the plurality of fiduciary markers are excited by the ultraviolet light and fluoresces at a wavelength within an ultraviolet spectrum.

In various embodiments, the controller is further programmed to correct alignment of the projected ultraviolet light with the first, second, and third line using the fiduciary markers.

The inventor additionally contemplates a dual waveband scanline red-green-blue (RGB) display system. This system typically includes a projection surface having a front side and a back side, the front side comprising a plurality of line twins, each line twin having a first line comprising a first fluorescent dye that emits fluorescence in a first color, and a second line comprising a second fluorescent dye that emits fluorescence in a second color. The back side is covered by a continuous layer of a third fluorescent dye that emits fluorescence in a third color. In preferred aspects, the first, second, and third colors are not the same and are selected from the group consisting of red, green, and blue. The system further include a first projector comprising a first controller operational coupled to a first digital micromirror device (DMD) chip, and first and second ultraviolet light sources optically coupled to the DMD chip, wherein the first and second ultraviolet light sources emit ultraviolet light at distinct wavelengths, wherein the controller is configured to receive video data comprising a plurality of frames, each frame containing a plurality of pixels, and each pixel having RGB information, wherein the first controller is programmed to cause the first DMD chip to project ultraviolet light from the first ultraviolet light source onto the first line and to project ultraviolet light from the second ultraviolet light source onto the second line, wherein the first controller is further programmed to illuminate only portions of the first and second lines in which corresponding pixels in the frame have the first and second color. The system may also include a second projector comprising a second controller operational coupled to a second digital micromirror device (DMD) chip, and a third ultraviolet light source optically coupled to the DMD chip, optionally wherein the third ultraviolet light source emits ultraviolet light at the same wavelength as the first or the second ultraviolet light source, wherein the second controller is configured to receive the video data comprising the plurality of frames, each frame containing the plurality of pixels, and each pixel having RGB information, wherein the second controller is programmed to cause the DMD chip to project ultraviolet light from the third ultraviolet light source onto the back side of the projection surface, wherein the second controller is further programmed to illuminate only portions of the back side in which corresponding pixels in the frame have the third color; and wherein the first and second projectors are configured to operate synchronously.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic illustrating an embodiment of a visual display system including a digital projector and a projection surface.

FIG. 2 is a perspective view illustrating an embodiment of the ultraviolet light source of the digital projector of FIG. 1.

FIG. 3 is a perspective view illustrating an embodiment of a scanning unit of the digital projector of FIG. 1.

FIG. 4 is a perspective view illustrating an embodiment of a light assembly of the digital projector of FIG. 1 with the light assembly including the ultraviolet light source and the scanning unit.

FIG. 5 is a perspective view illustrating an embodiment of the digital projector of FIG. 1 including the light assembly of FIG. 4.

FIGS. 6A-6B are perspective views illustrating embodiments of the projection surface of FIG. 1.

FIGS. 7A-7D are perspective views illustrating embodiments of an object including the projection surface of FIG. 1.

FIGS. 8A-8B are schematic illustrations of a single and dual wave RGB projection system.

FIGS. 9A-9B are exemplary views of an arrangement of different fluorescent pigments painted on a projection surface and a grayscale representation of the desired video effect to be projected onto the fluorescent pigments.

FIG. 10 is a flow chart of one embodiment of a single wave RGB projection system.

FIG. 11 is a flow chart of one embodiment of a dual wave RGB projection system.

FIG. 12 is a schematic illustration of a single wave scanline display system involving the use of a DMD chip.

FIG. 13 is a schematic illustration of a single wave scanline display system involving the use fluorescent display markers and a camera.

FIG. 14 illustrates various perspectives of a scanline display system with registration points to be scanned by a camera.

FIG. 15 is a schematic illustration of a dual waveband scanline RGB display system.

### DETAILED DESCRIPTION

The inventors have discovered various devices and methods for projecting an image on a projection surface using at least one ultraviolet light source to excite fluorescent material deposited on the surface to form images. The at least one ultraviolet light source may generate a single wavelength of ultraviolet light capable of exciting the fluorescent material to emit a color (e.g., red, green, blue, yellow, etc.). Alternatively, the at least one ultraviolet light source may generate a plurality of wavelengths of ultraviolet light capable of exciting a plurality of fluorescent materials to emit a variety of colors. Hence, the at least one scanning laser beam itself does not directly generate the light in red, green and blue that is seen by a viewer but instead the color light-emitting materials on the screen absorb the energy of the laser beam and emit light in red, green and blue in generating the images seen by the viewer. In exemplary embodiments, the inventors contemplate using a plurality of ultraviolet light sources with each light source configured to generate unique wavelengths of ultraviolet light that do not substantially overlap with one another. These wavelengths of ultraviolet light are capable of exciting a variety of fluorescent materials coupled to the projection surface to emit a variety of colors (e.g., red, green, blue, yellow, etc.), along with an increase in luminance of the fluorescent materials.

The fluorescent materials on the projection surface may be implemented with various materials. In addition, the projection surface may be in a variety of configurations. In one exemplary embodiment, the projection surface is a rectangular screen that includes three different fluorescent materials capable of being optically excited by the ultraviolet light to emit visible light in red, green, and blue colors suitable for forming images. The fluorescent materials may be formed on the projection surface as pixel dots arranged in parallel lines (e.g., repetitive sequential red pixel dot line, green pixel dot line, and blue pixel dot line). In another exemplary embodiment, an object (e.g., a dragonfly) includes a plurality of projection surfaces with each including at least one fluorescent material for animating the object.

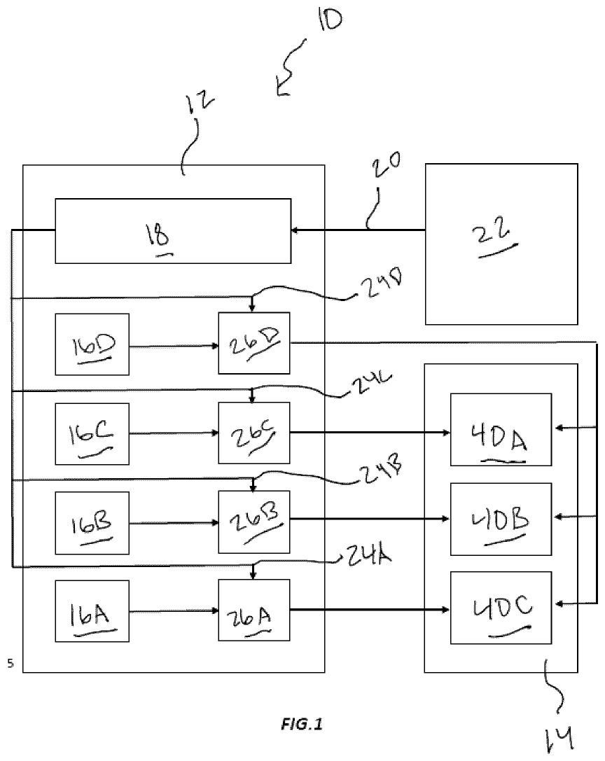

FIG. 1 is a block diagram illustrating an embodiment of a visual display system 10 including a digital projector 12 for projecting an image on a projection surface 14. The image may be utilized for a display viewed by a viewer (e.g., a cinema display, home theater display, marketing display, holographic display, etc.), a scene (e.g., background for film production, CG design, etc.), animatronics (e.g., amusement parks, interactive guidance, etc.), or combinations thereof.

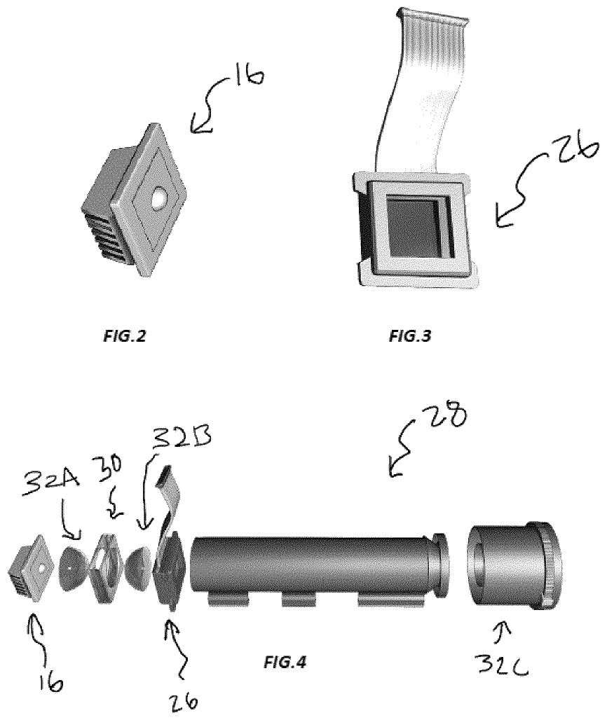

The digital projector 12 includes at least one ultraviolet light source 16. The at least one ultraviolet light source 16 may be provided by any light source capable of emitting ultraviolet light (e.g., ultraviolet light having wavelengths of less than 400 nm), such as a UV diode. In various embodiments, the ultraviolet light source 16 is capable of emitting a wavelength band having a range of less than 100 nm, less than 50 nm, less than 25 nm, less than 20 nm, less than 15 nm, less than 10 nm, less than 5 nm, or less than 1 nm. An exemplary embodiment of the ultraviolet light source 16 is shown in FIG. 2.

In various embodiments, the digital projector 12 includes a first ultraviolet light source 16A, a second ultraviolet light source 16B, a third ultraviolet light source 16C, and a fourth ultraviolet light source 16D. The first ultraviolet light source 16A emits ultraviolet light in a first wavelength band, the second ultraviolet light source 16B emits ultraviolet light in a second wavelength band, and the third ultraviolet light source 16C emits ultraviolet light in a third wavelength band. The first, second, and third wavelength bands do not substantially overlap. The fourth ultraviolet light source 16D emits ultraviolet light in a fourth wavelength band that overlaps with the first, second, and third wavelength bands. It is to be appreciated that the wavelength of the ultraviolet light emitted by each of the ultraviolet light sources 16 may be adjusted to provide flexibility to the visual display system 10 and thus adapt to the particular needs of the display, scene, or animatronic applications.

The digital projector 12 further includes a control circuit 18 configured to receive a video signal 20 from a video source 22 and to convert the video signal 20 to a red channel signal 24A, a green channel signal 24B, a blue channel signal 24C, or combinations thereof. In certain embodiments, the control circuit 18 is configured to receive the video signal 20 from the video source 22 and to convert the video signal 20 to a 4-channel signal. The 4-channel signal includes the red channel signal 24A, the green channel signal 24B, the blue channel signal 24C, and a luminance signal 24D. However, it is to be appreciated that the digital projector 12 may include any number of channels formed from the control circuit 18 (e.g., one, two, three, four, five, six, seven, eight, or even more). In these and other embodiments, the ultraviolet light sources 16 are electronically coupled to the control circuit 18.

The digital projector 12 further includes at least one scanning unit 26. The scanning unit 26 may include any device capable of scanning ultraviolet light. In certain embodiments, the scanning unit 26 includes a liquid crystal display (LCD) chip, a digital micro mirror (DMD), a galvanometer-based scanning motor, or combinations thereof. An exemplary embodiment of the scanning unit 26 includes the liquid crystal display (LCD) chip and is shown in FIG. 3.

In various embodiments, the digital projector 12 includes a first scanning unit 26A, a second scanning unit 26B, a third scanning unit 26C, and a fourth scanning unit 26D. The first, second, third, and fourth scanning units 26A, 26B, 26C, 26D are coupled to the first, second, third, and fourth ultraviolet light sources 16A, 16B, 16C, 16D, respectively. The first, second, third, and fourth scanning units 26A, 26B, 26C, 26D are further electronically coupled to the control circuit 18. The control circuit 18 uses the 4-channel signal to control operation of the first, second, third, and fourth scanning units 26A, 26B, 26C, 26D. As described in greater detail below, the inventor contemplates that the fourth ultraviolet light source 16D may be utilized to increase luminance of the image on the projection surface 14 based on the luminance signal 24D.

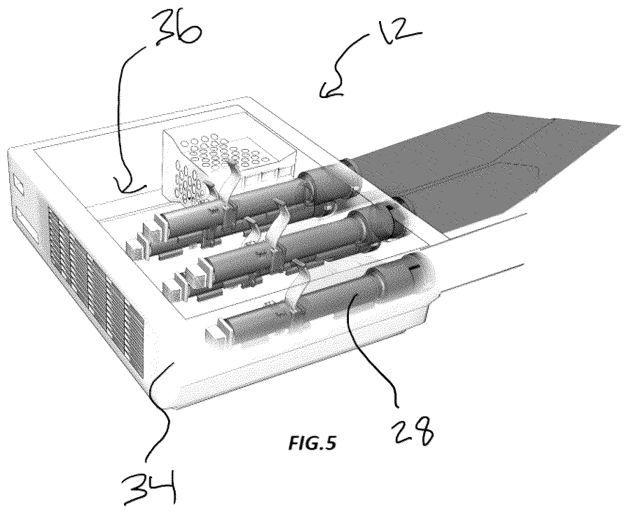

FIG. 4 is a perspective view illustrating an embodiment of a light assembly 28 including the ultraviolet light source 16. The light assembly 28 may further include a filter 30. The filter 30 may in optical communication with the ultraviolet light source 16 and the scanning unit 26 such that the ultraviolet light emitted from the ultraviolet light source 16 moves through the filter 30 and then through the scanning unit 26. In certain embodiments, the filter 30 includes a bandpass filter that transmits ultraviolet light in the desired wavelength band and rejects other wavelengths of light. It is to be appreciated that the light assembly 28 may include more than one filter, such as two filters, three filters, four filters, or even more.

The light assembly 28 may further include a lens 32. In certain embodiments, the light assembly 28 includes a collimating lens 32A, a condenser lens 32B, a focus/zoom lens 32C, or combinations thereof. The collimating lens 32A is in optical communication with the ultraviolet light source 16 and the filter 30 to narrow the ultraviolet light emitted from the ultraviolet light source 16 for moving through the filter 30. The condenser lens 32B is in optical communication with the filter 30 and the scanning unit 26 to expand the ultraviolet light from the filter 30 for moving through the scanning unit 26. The focus/zoom lens 32C is in optical communication with the scanning unit 26 to adjust the ultraviolet light from the scanning unit 26 for illuminating the projection surface 14.

FIG. 5 is a perspective view illustrating an embodiment of the digital projector 12. The digital projector 12 may include a cover 34 defining an interior space 36 The first ultraviolet light source 16A, the second ultraviolet light source 16B, the third ultraviolet light source 16C, and the fourth ultraviolet light source 16D may be disposed in the interior space 36. It is to be appreciated that the digital projector 12 may include more or less than three ultraviolet light sources 16, (e.g., one, two, three, five, six, seven or even more ultraviolet light sources 16). In exemplary embodiments, the digital projector 12 includes five ultraviolet light sources 16. In other embodiments, the digital projector includes four ultraviolet sources. Each of the ultraviolet light sources 16 are configured to have direct line of sight to the projection surface 14. In other words, the ultraviolet light generated by each of the ultraviolet light sources 16 are not combined to form a single source of ultraviolet light. However, it is to be appreciated that two or more of the ultraviolet lights generated by the ultraviolet light sources 16 may be combined.

The visual display system 10 may include a plurality of digital projectors 12, such as two, three, four, five, six, or even more. The plurality of digital projectors 12 may independently include any number of ultraviolet light sources 16. The plurality of digital projectors 12 may be configured to operate together, or independently, to provide ultraviolet light to one or more projection surfaces 14. In various embodiments, the digital projector 12 is modular such that one or more of the ultraviolet light sources 16 (or light assemblies 28) may be removed from the cover 34 yet remain in communication with the digital projector 12 (e.g., via a long communication cable). Furthermore, one or more of the ultraviolet light sources 16 (or light assemblies 28) of one digital projector 12 may be swapped with one or more of the ultraviolet light sources 16 (or light assemblies 28) of another digital projector 12 to provide flexibility to the visual display system 10 and thus adapt to the particular needs of the display, scene, or animatronic applications.

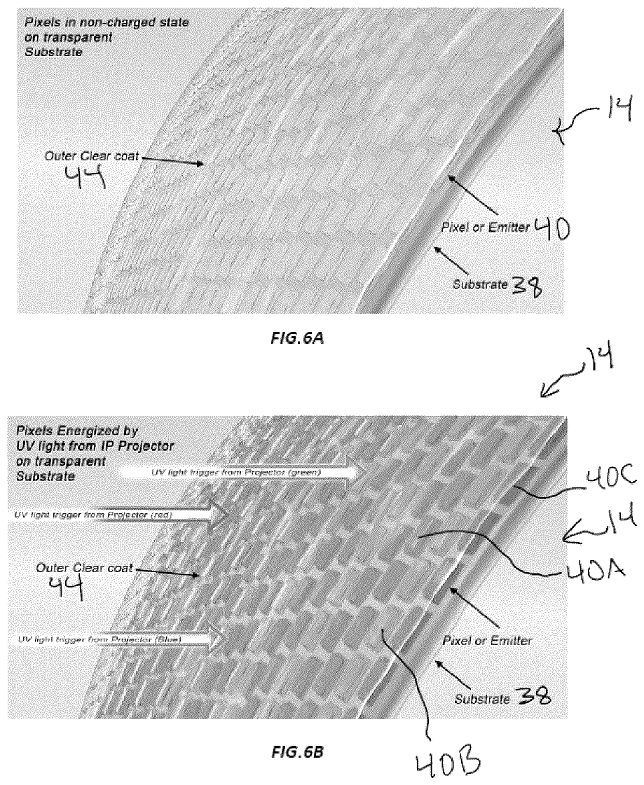

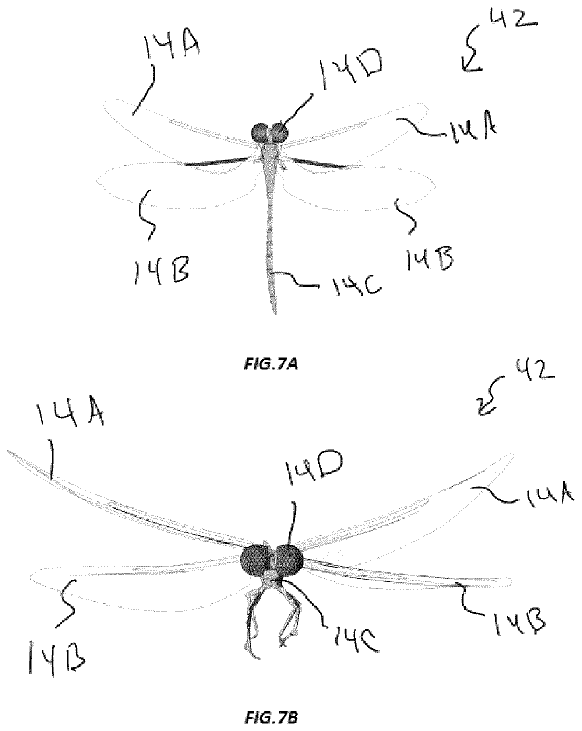

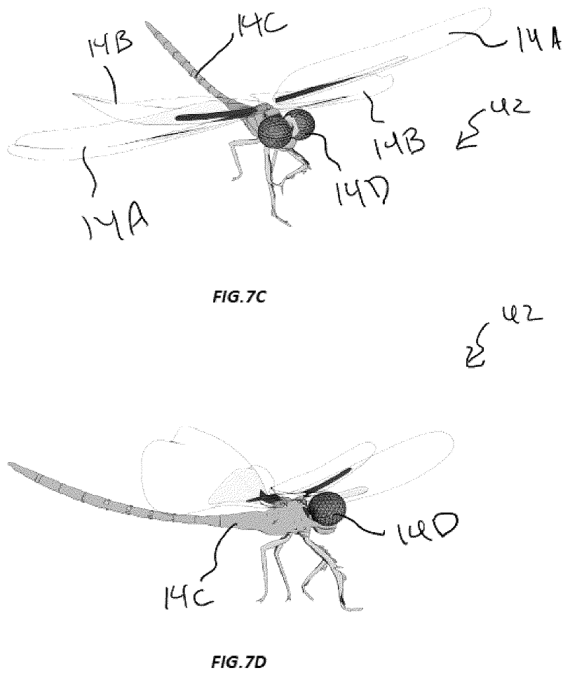

FIGS. 6A-B and 7A-D are perspective views of the projection surface 14. With particular reference to FIGS. 6A-B, the projection surface 14 includes a carrier substrate 38 and a fluorescent material 40 coupled thereto. The projection surface 14 is capable of receiving the ultraviolet light from the ultraviolet light source 16 and emitting visible light to be viewed by a viewer proximate to the projection surface 14. In particular, the ultraviolet light generated by the ultraviolet light source 16 excites the fluorescent material 40 that then emits visible light in response to the ultraviolet light. The projection surface 14 may be in any form known in the art. For example, the projection surface 14 may be configured as a rectangular screen. Alternatively, with particular reference to FIGS. 7A-D, the projection surface 14 may be configured in a shape of an object 42 to be animated, such as a dragonfly. However, it is to be appreciated that the projection surface 14 may be configured in the shape of other objects (e.g., a face of animatronic character).

The fluorescent material 40 is capable of fluorescing upon excitation by the ultraviolet light generated by the ultraviolet light source 16. In various embodiments, the fluorescent material 40 is substantially transparent in the presence of visible light, but not in the presence of ultraviolet light (see FIG. 6A). The term “substantially” as utilized herein means that the fluorescent material 40 has a transmittance to visible light in an amount of at least 50%, at least 60%, at least 70%, at least 80%, at least 90%, at least 95%, at least 96%, at least 97%, at least 98%, at least 99%, at least 99.5%, or even more in accordance with ASTM D1746-09. Any fluorescent material known in the art may be utilized so long as it is excited by ultraviolet light and emits visible light. For example, the fluorescent dye may be derived from or include rare earth minerals and/or organic materials such as pollen. For example, the projection surface 14 may include that is excited by ultraviolet light at a wavelength of less than 400 nm and emits visible light at a wavelength of between 400 nm and 700 nm (e.g., 630 nm for red-colored visible light, 532 nm for green-colored visible light, and 465 nm for blue-colored visible light). However, it is to be appreciated that other wavelengths of colored visible light may be utilized, such as those associated with the colors yellow and purple.

The fluorescent material 40 may include a fluorescent component, such as fluorophores, fluorescent energy transfer dyes, fluorescent pigments, fluorescent polymers, fluorescent proteins, or combinations thereof. The term “fluorophore” as utilized herein means fluorescent chemical compounds that can re-emit light upon light excitation. The phrase “fluorescent energy transfer dyes” as utilized herein means fluorescent dyes including a donor fluorophore and an acceptor fluorophore such that when the donor and acceptor fluorophores are positioned in proximity with each other and with the proper orientation relative to each other, the energy emission from the donor fluorophore is absorbed by the acceptor fluorophore and causes the acceptor fluorophore to fluoresce. The phrase “fluorescent pigments” as utilized herein means that the fluorophore is present in solution in a polymer matrix. Non-limiting examples of suitable fluorescent materials 40 include coumarins, pyrenes, perylenes, terrylenes, quaterrylenes, naphthalimides, cyanines, xanthenes, oxazines, anthracenes, naphthacenes, anthraquinones, thiazines, fluoresceins, rhodamines, asymmetric benzoxanthenes, xanthenes, phthalocyanines, squaraines, and combinations thereof. Other examples of suitable fluorescent materials 40 include europium, terbium, cerium, thulium, praseodymium, erbium, and combinations thereof. Additional examples of suitable fluorescent materials 40 can be found in U.S. Pat. No. 6,986,518 B2 which is incorporated herein by reference in its entirety.

With particular reference to FIG. 6B, in certain embodiments, the fluorescent material 40 may include a first fluorescent material 40A coupled to the carrier substrate 38 that emits fluorescence at a first color (e.g., red-colored visible light) when illuminated by ultraviolet light in the first wavelength band. The projection surface 14 may further include a second fluorescent material 40B that emits fluorescence at a second color (e.g., green-colored visible light) when illuminated by ultraviolet light in a second wavelength band. The projection surface 14 may further include a third fluorescent material 40C that emits fluorescence at a third color (e.g., blue-colored visible light) when illuminated by ultraviolet light in a third wavelength band. The first, second, and third colors are distinct and the first, second, and third wavelength bands do not substantially overlap. The term “substantially” as utilized herein means that the first, second, and third wavelength bands overlap in an amount of no greater 25%, no greater than 20%, no greater than 15%, no greater than 10%, no greater than 5%, no greater than 4%, no greater than 3%, no greater than 2%, no greater than 1%, no greater than 0.5%, no greater than 0.1%, or even less, based on a total distance of the wavelength band.

The fluorescent material 40 may include a fluorescent carrier. In various embodiments, the fluorescent component may be dispersed throughout the fluorescent carrier. The fluorescent component may be present in a weight ratio of the fluorescent component to fluorescent carrier of from 1:1000 to 1:1, from 1:500 to 1:1, from 1:100 to 1:1, from 1:50 to 1:1, from 1:25 to 1:1, or from 1:20 to 1:1. It is to be appreciated that depending on the type of fluorescent component utilized, the amount of the fluorescent component may be adjusted to normalize the emittance among the fluorescent materials 40 included in the projection surface 14. Non-limiting examples of suitable fluorescence carriers, include epoxy, acetate, polyethylene, or combinations thereof. The fluorescent material 40 may be applied to the carrier substrate 38 using any method known in the art for applying a material, such as a polymeric material, to a substrate. In certain embodiments, the fluorescent material 40 is applied utilizing additive manufacturing (e.g., printing).

The fluorescent material 40 may be arranged in any configuration or pattern known in the art for generating images for the display, scene, or animatronics. In certain embodiments, the first, second, and third fluorescent materials 40A, 40B, 40C are arranged to form a unit pixel in a pixel pattern. It is to be appreciated that the first, second, and third fluorescent materials 40A, 40B, 40C may be referred to as sub-pixels, e.g., a red (R) sub-pixel, a green (G) sub-pixel, and a blue (B) sub-pixel. It is contemplated, however, that any suitable color and number of sub-pixels may be utilized herein. For example, in various embodiments, a single fluorescent material 40 arranged in a pixel pattern may be utilized in various applications (e.g., special effects, particle visualizations, atmosphere visualizations for a scene, and the like). In other embodiments, a plurality of fluorescent materials 40 arranged in separate pixel patterns may be utilized with each of the fluorescent materials 40 disposed on a different carrier substrate 40 to generate animations similar to “cel animations” for various applications (e.g., special effects, particle visualizations, atmosphere visualizations for a scene, and the like).

With particular reference to FIG. 6B, in exemplary embodiments, the pixel pattern includes alternating rows of the first, second, and third fluorescent materials 40A, 40B, 40C. Each of the first, second, and third fluorescent materials 40A, 40B, 40C (i.e. each sub-pixel) may have a rectangular shape. In these and other embodiments, placement of the fluorescent materials 40 of each row is partially offset from the fluorescent materials 40 of the adjacent row. Non-limiting examples of other pixel patterns include quantum dot patterns, Bayer CFA patterns, and the like.

In other embodiments, the one or more fluorescent materials 40 may be coated or painted on the carrier substrate 38. The fluorescent materials 40 may be coated or painted in any configuration or orientation known in the art. In some embodiments of the projection surface 14 (e.g., dragonfly body and wings), the carrier substrate 38 may have a first area and a second area with the first area coated with the first fluorescent material 40A and the second area coated with the second fluorescent material 40B. It is to be appreciated that more than two fluorescent materials 40 may be utilized for more than two areas of the carrier substrate 38. It is also to be appreciated that the projection surface 14 may include more than one carrier substrate 38. Furthermore, it is to be appreciate that a plurality of projection surfaces 14 may be coated with different fluorescent materials 40 and then the plurality of projection surfaces 14 may be arranged relative to one another to form an assembly of the projection surfaces 14. For example, in the embodiment of a dragonfly, the body may be a projection surface, a first set of wings may be a projection surface, and the second set of wings may be a projection surface.

The carrier substrate 38 may be any material known in the art capable of supporting the fluorescent material 40. In various embodiments, the carrier substrate 38 is substantially transparent. The term “substantially” as utilized herein means that the carrier substrate 38 has a transmittance to visible light in an amount of at least 50%, at least 60%, at least 70%, at least 80%, at least 90%, at least 95%, at least 96%, at least 97%, at least 98%, at least 99%, at least 99.5%, or even more in accordance with ASTM D1746-09. Non-limiting examples of suitable materials for forming the carrier substrate include plastics (e.g. PVC, PET, polyacrylate, polystyrene, and polycarbonate), glass (e.g., silicates, borosilicate, lead crystal, alumina, silica, fused silica, quartz, glass ceramics, and metal fluorides), or combinations thereof. However, it is to be appreciated that the carrier substrate 38 may be opaque, such as for animating opaque objects or for front projection screens. The carrier substrate 38 may have a thickness in any amount suitable to achieve the desired properties of the projection surface 14.

The projection surface 14 may further include a coating layer 44 overlying the carrier substrate 38 and the fluorescent material 40. In certain embodiments, the coating layer 44 may at least partially encapsulate the fluorescent material 40. In various embodiments, the coating layer 44 is substantially transparent. The term “substantially” as utilized herein means that the coating layer 44 has a transmittance to visible light in an amount of at least 50%, at least 60%, at least 70%, at least 80%, at least 90%, at least 95%, at least 96%, at least 97%, at least 98%, at least 99%, at least 99.5%, or even more in accordance with ASTM D1746-09. Non-limiting examples of suitable coating layers include, or are formed from, polycarbonate, polyurethane, silicone, PET, polyethylene, or combinations thereof. The coating layer 44 may have a thickness in any amount suitable to achieve the desired properties of the projection surface 14.

The projection surface 14 may further include a photochromatic compound capable of decreasing the transmittance of visible light therethrough in the presence of a stimuli (e.g., infrared light, heat, electrical current, and the like). The photochromatic compound may be disposed between the carrier substrate 38 and the first, second, and third fluorescent materials 40A, 40B, 40C. In various embodiments, the photochromatic compound is substantially transparent in the absence of the stimuli. The term “substantially” as utilized herein means that the photochromatic compound has a transmittance to visible light in the absence of stimuli in an amount of at least 50%, at least 60%, at least 70%, at least 80%, at least 90%, at least 95%, at least 96%, at least 97%, at least 98%, at least 99%, at least 99.5%, or even more in accordance with ASTM D1746-09. In the presence of stimuli, the photochromatic compound may have a transmittance in an amount of no greater than 50%, no greater than 40%, no greater than 30%, no greater than 20%, no greater than 10%, no greater than 5%, no greater than 4%, no greater than 3%, no greater than 2%, no greater than 1%, no greater than 0.5%, or even less in accordance with ASTM D1746-09.

It is contemplated herein that the photochromatic compound may be utilized to improve the “black level” of the image or animation generated by the projection surface 14. The photochromatic compound may also be utilized to form shadows for a hologram generated by the projection surface 14. The photochromatic compound may be disposed opposite the position of the desired viewing orientation of the projection surface 14 by the viewer relative to the fluorescent material 40. In other words, the fluorescent material 40 may be disposed between the viewer and the photochromatic compound. In various embodiments, the photochromatic compound may react in the presence or absence of the stimuli at a rate slower than the rate of emission of visible light from the fluorescent material 40 in the presence of the ultraviolet light (i.e. refresh rate). To this end, the video signal 20 may include instructions for normalizing the refresh rates of the fluorescent material 40 and the photochromatic compound.

The projection surface 14 may further include one or more additives. Non-limiting examples of suitable additives include ultraviolet absorbers, adhesives, fillers, or combinations thereof. The ultraviolet absorber may be a film coupled to a component of the projection surface 14, a compound combined with a component of the projection surface 14, or a combination thereof. The ultraviolet absorber may be included with or in the coating layer 44 for minimizing exposure of the environment to ultraviolet light when the ultraviolet light source 16 provides ultraviolet light to the fluorescent material 40 through the carrier substrate 38 (e.g., rear projection screens). On the other hand, the ultraviolet absorber may be included with or in the carrier substrate 38 for minimizing exposure of the environment to ultraviolet light when the ultraviolet light source 16 provides ultraviolet light to the fluorescent material 40 through the coating layer 44 (e.g., front projection screens). The adhesive may be utilized to adhere components of the projection surface 14 to one another. The filler may be utilized to modulate one or more properties of the projection surface 14 (e.g., transmittance, color, texture, and the like). The additives may be utilized in any amount suitable to achieve the desired properties of the projection surface 14.

The visual display system 10 may further include a computing device capable of controlling the video source 22, the control circuit 18, or a combination thereof. In various embodiments, the computing device includes hardware and software (e.g., Adobe creative suite, Resulume, etc.) capable of controlling the components of the system 10 (e.g., a high-end workstation PC).

With reference to FIGS. 1, 4, and 5, as described above, the visual display system 10 is adaptable to the particular needs of the display, scene, or animatronics. During operation, the video source 22 generates the video signal 20 that is then received by the control circuit 18. Next, the control circuit 18 converts the video signal 16 to the red channel signal 24A, the green channel signal 24B, the blue channel signal 24C, or combinations thereof. In some exemplary embodiments, the control circuit 18 converts the video signal 20 to the 4-channel signal including the red channel signal 24A, the green channel signal 24B, the blue channel signal 24C, and the luminance signal 24D. In response to the 4-channel signal, the first, second, third and fourth ultraviolet light sources 16A, 16B, 16C, 16D emit ultraviolet light in the first, second, third, and fourth wavelength bands, respectively. The ultraviolet light emitted from the first, second, third and fourth ultraviolet light sources 16A, 16B, 16C, 16D are directed to the first, second, third, and fourth scanning units 26A, 26B, 26C, 26D through the lenses 32 and filters 30.

With reference to FIGS. 6A-B, the first, second, and third scanning units 26A, 26B, 26C direct the ultraviolet light to the first, second, and third fluorescent materials 40A. 40B, 40C of the projection surface 14 from the first, second, and third ultraviolet light sources 16A, 16B, 16C, respectively. The fourth scanning unit 26D directs the ultraviolet light to all of the fluorescent materials 40 illuminated by the first, second, and third ultraviolet light sources 16A, 16B, 16C. The fluorescent material 40 emits visible light in response to the ultraviolet light to form the image. To this end, the inventor contemplates that the fourth ultraviolet light source 16D may be utilized to increase luminance of the image on the projection surface 14 based on the luminance signal 24D by increasing the emission of visible light of all the fluorescent material 40 illuminated by the first, second, and third ultraviolet light sources 16A, 16B, 16C. In other embodiments when an increase in luminance is unnecessary, a separate image may be generated independent of the first, second, and third ultraviolet light sources 16A, 16B, 16C.

With reference back to FIGS. 4 and 5, in other exemplary embodiments, the control circuit 18 converts the video signal 20 to a first channel signal, a second channel signal, a third channel signal, a fourth channel signal, a fifth channel signal, and a sixth channel signal. In response to the channel signals, the first, second, third and fourth ultraviolet light sources 16A, 16B, 16C 16D emit ultraviolet light in the first, second, third, and fourth wavelength bands, respectively. In addition, this system 10 includes a fifth and sixth ultraviolet light sources that emit ultraviolet light in a fifth and a sixth wavelength bands, respectively. The ultraviolet light emitted from the first, second, third and fourth ultraviolet light sources 16A, 16B, 16C 16D are directed to the first, second, third, and fourth scanning units 26A, 26B, 26C, 26D through the filters 30 and the lenses 32 of the same, respectively. The ultraviolet light emitted from the fifth and sixth ultraviolet light sources (not shown) are directed to the fifth and sixth scanning units (not shown) through the filters 30 and the lenses 32.

With reference to FIGS. 7A-D, the first, second, third, and fourth scanning units 26A, 26B, 26C, 26D, along with the fifth and sixth scanning units, direct the ultraviolet light to the particular fluorescent material 40 of the projection surface 14 of the object 42 associated with each of the first, second, third, and fourth ultraviolet light sources 16A, 16B, 16C, 16D, along with the fifth and sixth scanning units. In particular, the object 42 may be a dragonfly including two sets of wings (a first projection surface 14A and a second projection surface 14B), a body portion (a third projection surface 14C), and eyes (a fourth projection surface 14D) with a recoil tab disposed between the sets of wings for providing a flutter to the wings in the presence of air movement. The first projection surface 14A includes a yellow fluorescent material and a minor portion of a blue fluorescent material, the second projection surface 14B includes a white fluorescent material and a minor portion of a blue fluorescent material, the third projection surface 14C includes a green fluorescent material and a purple fluorescent material, and the fourth projection surface 14D includes a red fluorescent material.

Prior to illumination of the object 42, the object 42 is substantially transparent. During illumination by the ultraviolet lights, the yellow, white, green, blue, purple, and red fluorescent materials emit visible light in response to form the image. It is contemplated herein that the ultraviolet light sources can be utilized to animate the dragonfly to exhibit a stylized blur, a noise map that strobes the ultraviolet light associated with the first projection surface 14A and the second projection surface 14B (the two sets of wings), and feedback to the viewer based on proximity of the viewer to the object 42. In particular, the ultraviolet light sources 40 illuminate the object 42, and the object 42 emits the ultraviolet light to animate the object 42 when the viewer approaches the object 42. As the viewer moves away from the object 42, the ultraviolet light sources 40 reduce illumination of the object 42.

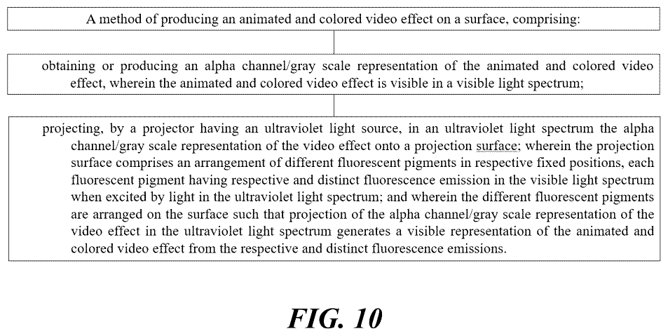

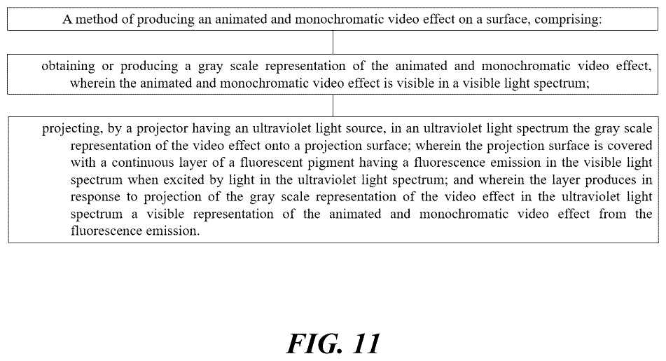

In another aspect of the inventive subject matter, a method of producing an animated and colored video effect on a surface is contemplated beginning with a step of obtaining or producing an alpha channel/gray scale representation 60 of the animated and colored video effect, wherein the animated and colored video effect is visible in a visible light spectrum. This method may further involve a step of projecting, by a projector 50 having an ultraviolet light source 55, in an ultraviolet light spectrum the alpha channel/gray scale representation 52 of the video effect onto a projection surface 70; wherein the projection surface comprises an arrangement of different fluorescent pigments 75 in respective fixed positions, each fluorescent pigment having respective and distinct fluorescence emission in the visible light spectrum when excited by light in the ultraviolet light spectrum, and wherein the different fluorescent pigments are arranged on the surface such that projection of the alpha channel/gray scale representation of the video effect in the ultraviolet light spectrum generates a visible representation of the animated and colored video effect from the respective and distinct fluorescence emissions. FIG. 10 depicts a flowchart of this exemplary method.

In one example of the contemplated method, a pattern may be painted or otherwise displayed on a surface using UV-excitable fluorescent pigments 75 arranged in fixed positions where different pigments fluoresce in different colors visible to the unaided eye. The fluorescent pigments 75 may be visible or invisible to the human eye under ambient light, but importantly the fluorescent pigments 75 fluoresce to emit visible light when exposed to UV. In some embodiments, the alpha channel/gray scale representation 60 is aligned, registered, and/or geometrically registered to the pattern such that after the projector 50 projects the alpha channel/gray scale representation 60 in UV light onto the surface 70, the alpha channel/gray scale representation 60 and the underlying pattern share common and/or corresponding spatial coordinates on the surface 70. For example, the alpha channel/gray scale representation 60 may be a pixel-for-pixel reproduction of the image and may be projected such that substantially every pixel of the image is illuminated by a corresponding pixel of UV light. Viewed from a different perspective, a single UV light source will project an alpha channel/gray scale representation at wavelengths not visible to the unaided eye, and the pattern of different fluorescent pigments will generate upon illumination with the UV light produce a colored image that is visible to the unaided eye. Notably, the alpha channel/gray scale representation can therefore be translated into any desired visible color space simply by choosing different pigments at specific locations that fluoresce at different desirable colors. Most typically, the alpha channel/gray scale representation will be a static image. It should be noted that, in preferred embodiments, the UV light spectrum is a UV-A spectrum.

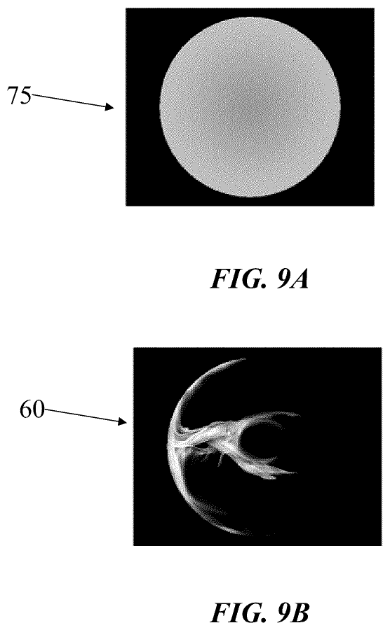

In other embodiments, the representation 60 may be a dynamic image and be registered to only a portion of the image (for example, at least 50%, 60%, 70%, 80%, or 90% by surface area), while excluding one or more regions of the image that are not intended to fluoresce. For example, different fluorescent pigments 75 may be arranged in a specific pattern such as a circle or square made from the UV-excitable fluorescent pigments, and the projected alpha channel/gray scale representation 60 will only illuminate a portion of the patterns. See FIG. 9A-9B. When the representation 60 is projected in ultraviolet onto the pattern of fluorescent pigments, the UV light at each pixel excites the co-located pigment, producing a colored and animated rendition of the representation 60 within the color pattern. This is especially advantageous for producing video effects that have predictable or narrow colors involved, such as a video effect of a burning flame. Even a static color pattern/map that only has red, orange, and yellow hues can be used for a wide range of alpha channel/gray scale representations of flames. This may also be advantageous for, as additional optional examples, producing a video effect of plants growing, an aurora borealis, lightning, fireworks, water effects, sparkles and twinkles, fireflies, smoke, particles, butterflies, veins or arteries, city lights, text, and more.

Therefore, in the above and further embodiments, it should be appreciated that the specific pattern of the fluorescent dyes is content-specific and not simply a uniform or (ir)regularly-shaped patters. As such, the position and type of fluorescent dye must be pre-visualized to generate the corresponding effect in the visible spectrum. Viewed from a different perspective, the type and location of the fluorescent dyes on the projection surface is a pre-illustrated static picture of an animation with fluorescent dyes in which the apparent motion in the visible wavelength range is supplied by a projector that emits UV light to excite the fluorescent dyes.

Furthermore, in some embodiments, it is contemplated that the different fluorescent pigments 75 comprise at least three, at least five, at least ten, or at least fifteen different fluorescent pigments. The use of a variety of different fluorescent pigments allows a more dynamic range of colors and effects of the resulting video effect. In some additional embodiments, at least two different fluorescent pigments are located in the same fixed position to thereby generate a fluorescence emission that is different from a fluorescence emission of the at least two different fluorescent pigments individually. In still further embodiments, the arrangement of the different fluorescent pigments 75 in the respective fixed positions produces a visible color gradient when illuminated by the ultraviolet light spectrum across the fixed positions.

In a typical use case, the alpha channel/gray scale representation 60 is provided to the projector 50, typically as an animation in a video format. For example, the animation may be provided to the projector in some embodiments by physical means, such as by coupling a computer storing the animation as a video file to the projector using an HMDI, VGA, display port, USB-C, or any other cable. In other embodiments, the animation/representation 60 may be provided to the projector 50 by wireless means, such as by screen mirroring the animation 60 to the projector or using an application to cast the animation wirelessly to a compatible projector. In yet further embodiments, the projector 50 may be coupled to a camera that provides live feed to the projector, and the projector 50 may identify an image within the live feed to produce a corresponding animation that may or may not change dynamically based on changes in the live feed.

Regardless of the particular means of providing the animation 60 to the projector 50, the projector 50, in typical embodiments, can project UV light, and the projector 50 projects the grayscale/alpha sequence 60 in UV. It is contemplated that the projector 50 may modulate UV intensity across the surface 70 over space and time, allowing the projector 50 to generate a particular hue of a fluorescent pigment(s), and/or to make a fluorescent pigment 75 as bright as desired, even to the point of being white. The different pigments at each location emit distinct visible colors when excited by the UV. As the projected UV intensity changes over time at each illuminated pixel, the emitted brightness and/or hue changes accordingly, thereby producing a visible animated, colored effect.

In some embodiments, the projector 50 emits ultraviolet light within the UV-A band (e.g., 315-400 nm) or within only a single wavelength band (for example, 365 nm±10 nm), and the fluorescent pigments 75 on the surface are selected such that this band excites each pigment present in the illuminated regions. Because each pigment emits a distinct visible color when excited, a properly pre-visualized alpha channel/gray scale representation 60 can produce a colored, animated video effect on the surface. In some embodiments, the surface 70 may be transparent or opaque, depending on use.

It is contemplated that these methods of producing animated and colored video effects have several advantages over the prior art. For instance, the presently disclosed system has a lower cost than a 3 or 4 channel projection system. This is primarily because the systems herein require only a single emission channel, such as a single UV emitter that only projects one wavelength band, as opposed to projection systems that require 3 or 4 visible emitters at narrowly defined wavelength (bands). Further, the disclosed system does not require a color combiner or multiple Digital Micromirror Devices (DMDs). Additionally, the disclosed system is effective for a broad range of visual-effects applications and can be implemented easily. For example, it can be implemented entirely with commercially available hardware and control software and with readily available fluorescent pigment compounds. Once the concept is understood and initial registration is completed, authoring and operation are straightforward, often requiring only grayscale/alpha assets and painting on the desired surface with the appropriate fluorescent pigments. The system may operate at longer near-UV wavelengths (e.g., about 385-395 nm) that are sufficient to excite the pigments and can present safety and compliance advantages relative to systems employing multiple visible or shorter-wavelength UV channels, however it should be appreciated that any UV wavelength is suitable as desired. Because output is driven by a single UV channel rather than multiple color channels, the system is also less sensitive to LED thermal drift and associated color-balance shifts, improving stability over time.

In some embodiments, additional suitable and advantageous uses of the disclosed systems include producing video effects for cars, parties, theme parks, live theater, consumer or signage use, holographic displays, holographic interfaces, and more. For example, in some embodiments, this technology is suitable for use in military operations, such as psychological operations (PSYOP). In these contexts, the projection systems disclosed herein can be used to quickly simulate combat conditions such as targets and enemy avatars, weather/terrain effects, smoke, fire, explosions, targets in low light, and other uses. This is especially useful when combined with audio devices.

In various embodiments, the distance between the emitter and the screen is selected depending on intended use, image size, image clarity, UV power output, and/or other factors. For example, in some embodiments, the emitter may be positioned close to the screen, such as 5 centimeters (cm), 10 cm, 15 cm, 20 cm, 25 cm, or 30 cm from the screen. This is preferred for home, classroom, and signage applications. For medium distances, such as 1.0 meter (m), 1.5 m, 2.0 m, 2.5 m, 3.0 m, or 3.5 m, the setup is still simple enough to use in home, classroom, and signage applications, but may also be appropriate for small rooms, studios, and simulators. Placements between about 3.5 m to 10 m from the screen would be ideal in many common conference rooms and home-theaters. For applications where the emitter is placed in the back of the room or at a venue, such as a movie theater, ballroom, or other larger venue, distances of 10 m to 20 m may be suitable. For applications such as auditoriums, stages, and attractions, even greater distances exceeding 20 m may be suitable, including 25 m, 30 m, 35 m, 40 m, 45 m, 50 m, or even greater. It should be noted that the further away the emitter is, the more calibration may be needed for accurate registration and/or alignment of the UV light to the image. Thus, in any embodiment of the contemplated invention, a UV projection system may further include a controller and/or camera that maintains the proper registration and/or alignment of the UV light.

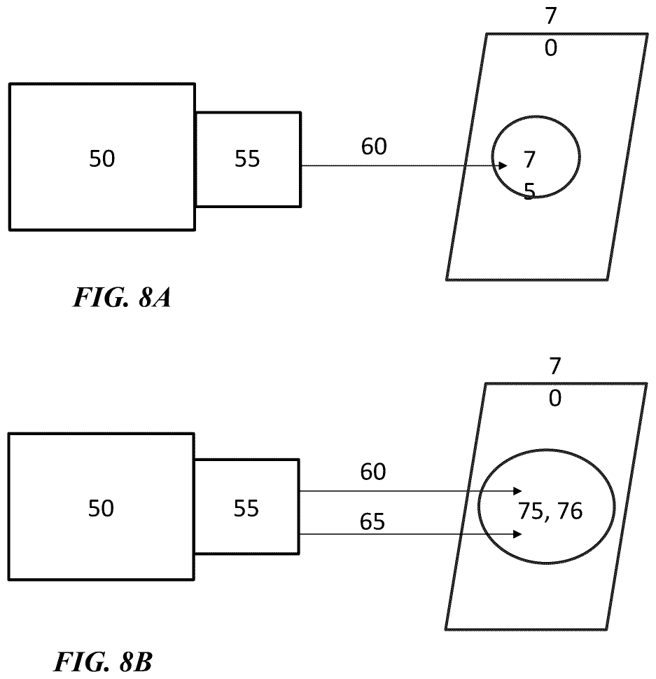

In further embodiments of the presently disclosed projection system, rather than using a single wave projection, a dual wave form of the system is contemplated in which a first set of distinct pigments emitting fluorescence at different wavelengths can be excited by a first UV source having a first UV wavelength band, and in which a second set of distinct pigments emitting fluorescence at different wavelengths can be excited by a second UV source having a second UV wavelength band that is different from the first UV wavelength band. For example, a method of producing an animated and colored video effect described herein may further comprise a step of projecting, in a second and distinct UV light spectrum a second and distinct alpha channel/grayscale representation 65 of a second and distinct video effect onto the projection surface, wherein the projection surface comprises a second and distinct arrangement of different fluorescent pigments 76 in respective fixed positions, each fluorescent pigment having respective and distinct fluorescence emissions in the visible light spectrum only when excited by light in the second and distinct ultraviolet light spectrum. FIG. 8B depicts an exemplary schematic of such a system in which a second a distinct alpha channel/grayscale representation of a second and distinct video effect, which is projected onto a projection surface comprising a second and distinct arrangement of different fluorescent pigments in fixed positions.

In some of these dual wave RGB projection embodiments, both the first 60 and second alpha channel/grayscale representations 65 may be projected onto the same projection surface 70 by the same projector 50. However, in other aspects, two or more distinct projectors 50 may be used. In preferred embodiments, regardless of the number of projectors, all projected UV light is from the UV-A light spectrum.

It should be appreciated that the second and distinct arrangement of different fluorescent pigments 76 in respective fixed positions may be mixed with the first arrangement of fluorescent pigments 75. For example, a first paint comprising a first group of fluorescent pigments 75 that emit light in the visible spectrum only when excited by light in a first UV spectrum may be mixed with a second paint comprising a second group of fluorescent pigments 76 that emit light in the visible spectrum only when excited by light in a second UV spectrum. By mixing the two paints together, it is possible to have a single pixel be selectively illuminated by only the first UV spectrum, only the second UV spectrum, or by both the first and second spectra simultaneously. However, it should be further appreciated that the first and second paints may alternatively or additionally be painted over separate portions of the projection surface 70.

In one example, the first arrangement of different fluorescent pigments 75 may comprise a transparent red pigment that excites at 365 nm and not before, and the second paint may comprise a blue pigment that excites at 400 nm. Because blue-emitting pigments, among others, is partially excited and emitted by the fluorescent pigment at smaller UV wavelengths such as 350 nm to 400 nm, with excitation efficiency decreasing below about 370 nm, a mixture of the red-emitting and blue-emitting pigments may produce interesting results. For example, when the first and second paints are mixed and/or co-located on the surface, UV illumination near 365 nm preferentially excites the red pigment, illumination near 400 nm preferentially excites the blue pigment, and intermediate wavelengths such as 370 nm to 390 nm, produce blends. This enables the emitted light to come in a range of different hues as desired. Additionally, the selection between transparent and opaque pigments can also enable latitude and flexibility in the hues. Such a mixture may also enable either minimal ambient-light visibility with UV-only emission or enhanced ambient-visible coloration that intensifies under ultraviolet illumination.

In some embodiments, the second and distinct arrangement of different fluorescent pigments 76 comprises fluorescent pigments that emit fluorescence within a range of between 450 nm and 720 nm.

Remarkably, it was also discovered herein that mixing fluorescent pigments (in some cases responsive to different excitation wavelengths) can produce results that would not be expected. For instance, for certain mixtures, increasing the value or intensity of the projected UV light not only increases brightness but can also produce a perceptible hue shift. Indeed, the inventor identified specific combinations of pigments that reliably yielded desired animated color behaviors under specified ultraviolet wavelengths and intensity ranges.

In another aspect of the inventive subject matter, a single wave grayscale projection system is contemplated for producing an animated and monochromatic video effect. For example, one method of producing an animated and monochromatic video on a surface 70 involves the step of obtaining or producing a gray scale representation 60 of the animated and monochromatic video effect, wherein the animated and monochromatic video effect is visible in a visible light spectrum. An additional step involves projecting, by a projector 50 having an ultraviolet light source 55, in an ultraviolet light spectrum the gray scale representation 60 of the video effect onto a projection surface 70, wherein the projection surface 70 is covered with a continuous layer of a fluorescent pigment 75 (or mixture thereof) having a fluorescence emission in the visible light spectrum when excited by light in the ultraviolet light spectrum. The layer 75 produces in response to projection of the gray scale representation 60 of the video effect in the ultraviolet light spectrum a visible representation of the animated and monochromatic video effect from the fluorescence emission. FIG. 8A depicts an exemplary schematic which may be applicable to either the system involving an alpha channel/grayscale representation 60 or the system involving only a grayscale representation 60.

The most notable differences between the single wave grayscale projection system and the single wave RGB projection system are that the grayscale projection system does not require an alpha channel and a single fluorescent pigment may be used on the screen. Rather than projecting different wavelengths of UV to distinctly excite different fluorescent pigments, this simplified system uses a grayscale representation to modulate the luminance level of the emitted UV light (the UV intensity) at each pixel, and the uniform fluorescent layer converts that UV into a visible emission. This is suitable for embodiments where a single wavelength or wavelength band is emitted. The result is an animated, monochromatic visible effect whose shapes, motion, and shading come from the projected grayscale representation. In some embodiments of the grayscale system, the projection surface comprises an opaque surface, which may be more suitable than a transparent surface in certain embodiments.

Therefore, and in some embodiments, the visible representation of the animated and monochromatic video effect from the fluorescence emission has a single color within a range of between 450 nm and 720 nm.

In some embodiments, the continuous layer may be substantially continuous. Additionally, and in different embodiments, the projection surface is coated with a substantially continuous layer comprising a single type of fluorescent pigment that responds within a selected ultraviolet band across the entire projection surface. Therefore, it should be appreciated that the UV source may be a laser, narrow band, or wide band light source (preferably within the UV-A band). In these embodiments, the visible effect is substantially one color, with brightness selectively modulated at each pixel by the projected grayscale gradient. In one example, a dark or black screen is treated with a smooth with fluorescing compound to form the continuous layer.

However, in other embodiments where a non-monochromatic video effect is desired, while still desiring the use of a single grayscale representation and no alpha channel, the continuous layer may comprise a mixture of two or more fluorescent pigments having distinct excitation spectra and/or intensity-response characteristics. When the grayscale representation is projected in ultraviolet onto such a layer, the visible output at each location may be different depending on the pigments used and the UV intensity emitted.

One particular advantage of the grayscale projection system is the ability to easily modify and implement an older or smaller projector into the system. For example, almost any existing projector can be modified to include a UV LED light. The same optics of the existing projector may be used, thus avoiding the need for registering the two video streams (the visible-light stream and the UV stream).

In a normal projector, the projected video effect would typically be lost on a dark or black surface, typically because the surface would reflect very little visible light. In the contemplated invention, the UV LED, optionally in combination with a controller or modulator, projects a grayscale pattern to boost the white levels of the bright portions of the image by causing them to fluoresce. The emitted UV light raises the luminance of the bright portions, thus allowing a wider and more dynamic range of the image.

Therefore, and in some additional embodiments, the visible representation of the animated and monochromatic video effect from the fluorescence emission has a white color, and optionally further comprising a step of projecting a representation of the video effect in a visible light spectrum onto the projection surface such that the visible representation of the animated and monochromatic video effect from the fluorescence emission and the representation of the video effect in the visible light spectrum are registered. This projection of the visible light image onto the surface, combined with the registered animated and monochromatic video effect which comprises white light, is especially advantageous for modifying, brightening, and/or enhancing existing projectors and/or their images.

While this grayscale projection design is typically suitable for use with a single projector, it is possible to uses two projectors. When two projectors are used, a first projector may emit visible light while a second projector emits UV light. This may be more challenging due to the need to register the two projected image and keep them aligned over time. In preferred embodiments, regardless of the number of projectors, any emitted UV light is from the UV-A spectrum.

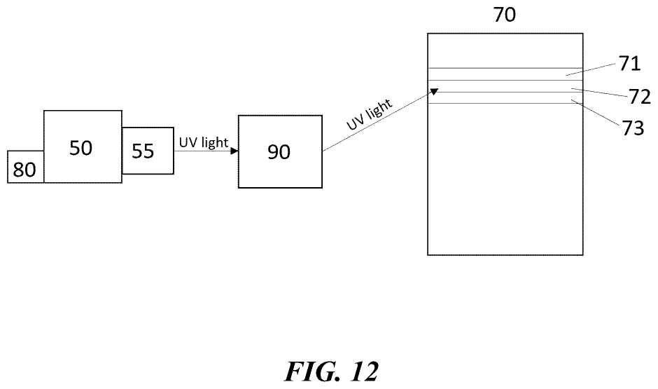

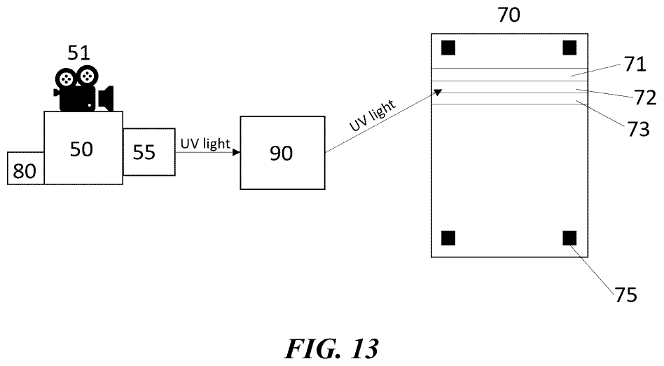

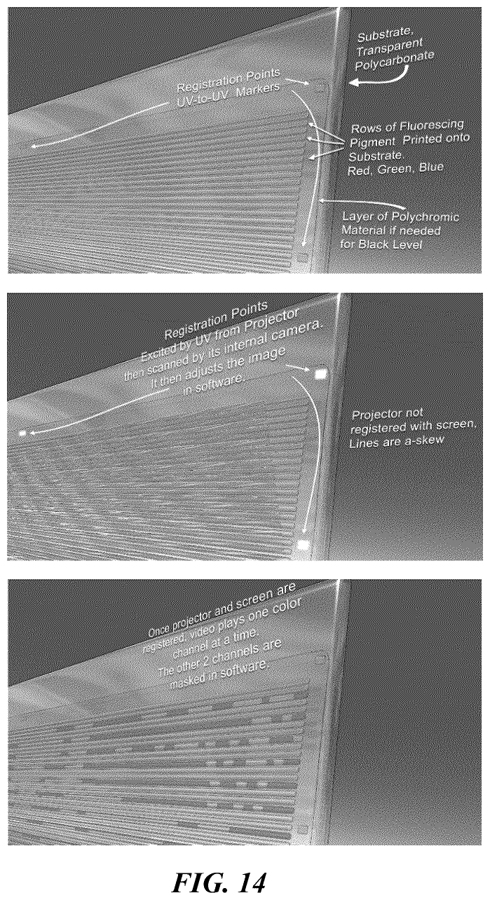

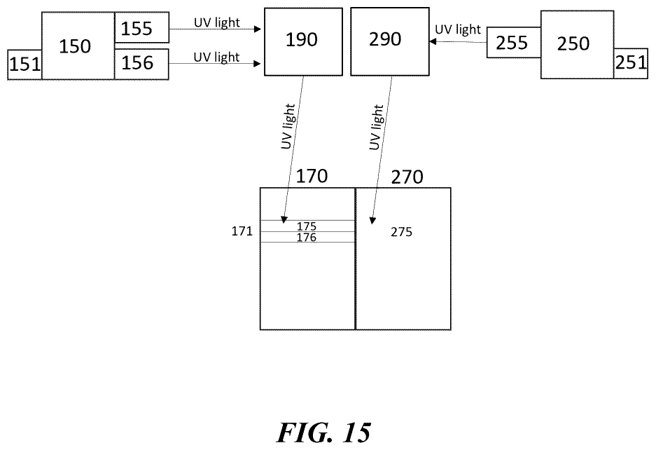

In a different aspect of the inventive subject matter, a single waveband scanline RGB display system is contemplated. This scanline system typically includes a projection surface 70 comprising a plurality of line triplets 71, 72, 73, each line triplet comprising a first line 71 comprising a first fluorescent dye that emits fluorescence in a red light, a second line 72 comprising a second fluorescent dye that emits fluorescence in a green light, and a third line 73 comprising a third fluorescent dye that emits fluorescence in a blue light. This scanline system also includes a projector 50 comprising a controller 80 operationally coupled to a digital micromirror device (DMD) chip 90, and an ultraviolet light source 55 optically coupled to the DMD chip 90, wherein the controller 80 is configured to receive video data comprising a plurality of frames, each frame containing a plurality of pixels, and each pixel having RGB information, wherein the controller is programmed to cause the DMD chip to project ultraviolet light onto the first, second, and third line, one at a time per frame, and wherein the controller is further programmed to illuminate only portions of the first, second, and third line in which corresponding pixels in the frame have red, green, and/or blue color. FIG. 12 depicts an exemplary schematic of this scanline embodiment.

In an embodiment, the scanline system delivers a true RGB image on a fluorescing BG screen. This is possible in part due to the high-frequency DMD chip 90, which can self-correct the image registration extremely rapidly (i.e. every 0.1 milliseconds(s), every 0.5 ms, every 1.0 ms, etc.). Conventional projectors must line up the red, green, and blue images perfectly. Misalignment of colors causes blurring and unintended mixing of colors. The scanline system, paired with the DMD chip 90, resolves this issue. For example, in the scanline system, typically all three types of lines can be excited by the same wavelength or wavelength band of UV light, regardless of what color the pigment emits when excited. Because the lines are horizontally, or in some embodiments vertically, laid out across the screen, the projector 50 can target only the lines that emit a specific color at a time, using the data and instructions from the controller 80. For example, at one point in time, the projector 50 may emit UV only to the red-emitting lines 71 via the DMD chip 90. In the next moment, the projector 50 may emit UV only to the green-emitting lines 72. The projector 50 utilizes the DMD chip 90 and the controller 80 to accomplish the precise excitation of one line type at a time.

Hundreds or even thousands of times per second, the DMD chip 90 projects a UV pattern that lands only where, for example, the red-emitting lines 71 are located on the screen. The system can mask the blue and green lines 73, 72, during this time period, such as through software, if needed. The DMD chip 90 then projects UV only to the green-emitting lines 72, and then only to the blue-emitting lines 73. The process then repeats. These emissions occur so rapidly that, to a human observer, they appear as a single, fully colored image.

In some embodiments, the projection surface 70 further comprises a plurality of fiduciary markers 75, wherein the projector further comprises a camera 51 that is configured to acquire a fluorescence signal (preferably in the UV range) from the fiduciary markers 75. The camera 51 may be an especially advantageous feature of the scanline system, as it maintains the proper registration and/or alignment of the projector 50 to the screen 70. For example, the fiduciary markers 75 may be invisible markers that only become visible in the UV when excited by UV light. The camera 51 can see the markers 75. Using software, the camera 51 uses these markers 75 as reference points to determine whether there has been any change that causes misalignment between the projector 50 and the screen 70. When a misalignment is detected, the DMD chip's 90 internal mirrors are quickly corrected to re-align the projector 50 to the lines 71, 72, 73. In embodiments, the camera 51 may be operationally coupled to the controller 80 and/or to the projector 50. In this context, it should be particularly recognized that a true RGB composite image (or video) can be generated on a surface using a single waveband or even wavelength excitation light (preferably in the UV-A band) whereas other UV excitation would require separate excitation wavelengths with isolated and narrow wavelength bands.

In any preferred aspect of the scanline system, any emitted UV light is from the UV-A light spectrum.

In another embodiment, the scanline system as described above may be modified as a dual wave RGB scanline build. For example, a dual waveband scanline RGB display system may comprise a projection surface having a front side 170 and a back side 270, the front side comprising a plurality of line twins 171, each line twin 171 comprising a first line 175 comprising a first fluorescent dye that emits fluorescence in a first color (e.g., red), a second line 176 comprising a second fluorescent dye that emits fluorescence in a second color (e.g., blue), and wherein the back side is covered by a continuous layer 275 of a third fluorescent dye that emits fluorescence in a third color (e.g., green). Further, the first, second, and third colors are not the same and are selected from the group consisting of red, green, and blue. The system further include a first projector 150 comprising a first controller 151 operationally coupled to a first digital micromirror device (DMD) chip 190, and first and second ultraviolet light sources 155, 156, optically coupled to the DMD chip, wherein the first and second ultraviolet light sources 155, 156, emit ultraviolet light at distinct wavelengths, wherein the controller 151 is configured to receive video data comprising a plurality of frames, each frame containing a plurality of pixels, and each pixel having RGB information, wherein the first controller 151 is programmed to cause the first DMD chip 190 to project ultraviolet light from the first ultraviolet light source 155 onto the first line 175 and to project ultraviolet light from the second ultraviolet light source 156 onto the second line 176, wherein the first controller 151 is further programmed to illuminate only portions of the first and second lines 175, 176, in which corresponding pixels in the frame have the first and second color. The system may also include a second projector 250 comprising a second controller 251 operationally coupled to a second digital micromirror device (DMD) chip 290, and a third ultraviolet light source 255 optically coupled to a DMD chip 290, optionally wherein the third ultraviolet light source 255 emits ultraviolet light at the same wavelength as the first or the second ultraviolet light source 155, 156, wherein the second controller 251 is configured to receive the video data comprising the plurality of frames, each frame containing the plurality of pixels, and each pixel having RGB information, wherein the second controller 251 is programmed to cause the DMD chip 290 to project ultraviolet light from the third ultraviolet light source 255 onto the back side 270 of the projection surface, wherein the second controller 251 is further programmed to illuminate only portions of the back side 270 in which corresponding pixels in the frame have the third color; and wherein the first and second projectors 150, 250, are configured to operate synchronously.

The advantage of this dual wave RGB scanline build over the single wavelength scanline embodiment is that, because one side of the screen has only two types of color-emitting lines, such as red and blue, while the third color-emitting pigments are on the other side of the screen, the side with two types of color-emitting lines will have fewer issues with registration. The first DMD chip 190 can afford significantly more inaccuracy in where it projects UV light because the width of each line 175, 176 of the line twin 171 is larger than it could be if three different types of lines all fit together on the same side of the screen. In addition, two or even three different wavelengths of UV light may be employed, if desired. In an example where multiple wavelengths of UV light are used, even more inaccuracy can be tolerated without affecting the image because, if the registration drifts, one wavelength will not affect the “wrong” pigments because each line type only responds to its own unique wavelength of light.

In additional embodiments, three projectors can be used rather than two. For example, one projector to excite the red lines, one to excite the blue lines, and one to excite the green lines. It is contemplated that in some embodiments of the dual wave RGB scanline build that, on the side of the screen with two different line types, there is a negative space in between each line.

The disclosed methods and systems are readily distinguishable from the prior art. For example, US Pub. No. 20100020290 A 1 to Kemp (“Kemp”) does not disclose the projection of a grayscale/alpha channel in a UV spectrum or a projection surface with different fluorescent pigments which serve as the primary color-forming mechanism. Kemp additionally does not teach a DMD scanline, nor does it teach the use of a camera and fiduciary markers to maintain registration. Further, US Pub. No. 20110109529 A 1 to Hajjar (“Hajjar”) also fails to teach the projection of an alpha channel/grayscale representation of a video effect and the DMD scanline system combined with elements like fiduciary markers for simplified registration. In addition, US Pub. No. 20080213625 A 1 to Raymo (“Raymo”) deals with data storage and retrieval, and does not concern projection or display architectures, let alone UV alpha/grayscale projection, DMD scanlines, or camera-based registration. Accordingly, none of Kemp, Hajjar, or Raymo, alone or in combination, discloses or suggests the limitations of the present invention.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. A method of producing an animated and colored video effect on a surface, comprising:
obtaining or producing an alpha channel/gray scale representation of the animated and colored video effect, wherein the animated and colored video effect is visible in a visible light spectrum;
projecting, by a projector having an ultraviolet light source, in an ultraviolet light spectrum the alpha channel/gray scale representation of the video effect onto a projection surface;
wherein the projection surface comprises an arrangement of different fluorescent pigments in respective fixed positions, each fluorescent pigment having respective and distinct fluorescence emission in the visible light spectrum when excited by light in the ultraviolet light spectrum; and
wherein the different fluorescent pigments are arranged on the surface such that projection of the alpha channel/gray scale representation of the video effect in the ultraviolet light spectrum generates a visible representation of the animated and colored video effect from the respective and distinct fluorescence emissions.

2. The method of claim 1, wherein the ultraviolet light spectrum is a UV-A spectrum.

3. The method of claim 1, wherein the different fluorescent pigments are at least 10 different fluorescent pigments.

4. The method of claim 1, wherein at least two different fluorescent pigments are located in the same fixed position to thereby generate a fluorescence emission that is different from a fluorescence emission of the at least two different fluorescent pigments individually.

5. The method of claim 1, wherein the arrangement of the different fluorescent pigments in the respective fixed positions produces a color gradient when illuminated by the ultraviolet light spectrum across the fixed positions.

6. The method of claim 1, wherein the visible representation of the animated and colored video effect has substantially the same color palette as the animated and colored video effect from which the alpha channel/gray scale representation was made.

7. The method of claim 1, wherein the projection surface is transparent.

8. The method of claim 1, further comprising a step of projecting, in a second and distinct ultraviolet light spectrum a second and distinct alpha channel/gray scale representation of a second and distinct video effect onto the projection surface, wherein the projection surface comprises a second and distinct arrangement of different fluorescent pigments in respective fixed positions, each fluorescent pigment having respective and distinct fluorescence emission in the visible light spectrum only when excited by light in the second and distinct ultraviolet light spectrum.

9. The method of claim 8, wherein the second and distinct alpha channel/gray scale representation of a second and distinct video effect is projected onto the projection surface by the same projector.

10. The method of claim 8, wherein the second and distinct arrangement of different fluorescent pigments comprises fluorescent pigments that emit fluorescence within a range of between 450 nm and 720 nm.

11. A method of producing an animated and monochromatic video effect on a surface, comprising:
obtaining or producing a gray scale representation of the animated and monochromatic video effect, wherein the animated and monochromatic video effect is visible in a visible light spectrum;
projecting, by a projector having an ultraviolet light source, in an ultraviolet light spectrum the gray scale representation of the video effect onto a projection surface;
wherein the projection surface is covered with a continuous layer of a fluorescent pigment having a fluorescence emission in the visible light spectrum when excited by light in the ultraviolet light spectrum; and
wherein the layer produces in response to projection of the gray scale representation of the video effect in the ultraviolet light spectrum a visible representation of the animated and monochromatic video effect from the fluorescence emission.

12. The method of claim 11, wherein the projection surface comprises an opaque surface.

13. The method of claim 11, wherein the visible representation of the animated and monochromatic video effect from the fluorescence emission has a white color.

14. The method of claim 11, wherein the visible representation of the animated and monochromatic video effect from the fluorescence emission has a single color within a range of between 450 nm and 720 nm.

15. The method of claim 11, wherein the visible representation of the animated and monochromatic video effect from the fluorescence emission has a white color, and optionally further comprising a step of projecting a representation of the video effect in a visible light spectrum onto the projection surface such that the visible representation of the animated and monochromatic video effect from the fluorescence emission and the representation of the video effect in the visible light spectrum are registered.

16. A single waveband scanline red-green-blue (RGB) display system, comprising:
a projection surface comprising a plurality of line triplets, each line triplet comprising
a first line comprising a first fluorescent dye that emits fluorescence in a red light,
a second line comprising a second fluorescent dye that emits fluorescence in a green light, and
a third line comprising a third fluorescent dye that emits fluorescence in a blue light;
a projector comprising a controller operationally coupled to a digital micromirror device (DMD) chip, and an ultraviolet light source optically coupled to the DMD chip;
wherein the controller is configured to receive video data comprising a plurality of frames, each frame containing a plurality of pixels, and each pixel having RGB information,
wherein the controller is programmed to cause the DMD chip to project ultraviolet light onto the first, second, and third line, one at a time per frame; and
wherein the controller is further programmed to illuminate only portions of the first, second, and third line in which corresponding pixels in the frame have red, green, and/or blue color.

17. The RGB display system of claim 16, wherein the projection surface further comprises a plurality of fiduciary markers, wherein the projector further comprises a camera that is configured to acquire a fluorescence signal form the fiduciary markers.

18. The RGB display system of claim 17, wherein the plurality of fiduciary markers are excited by the ultraviolet light and fluoresce at a wavelength within an ultraviolet spectrum.

19. The RGB display system of claim 16, wherein the controller is further programmed to correct alignment of the projected ultraviolet light with the first, second, and third line using the fiduciary markers.

20. A dual waveband scanline red-green-blue (RGB) display system, comprising:
a projection surface having a front side and a back side, the front side comprising a plurality of line twins, each line twin comprising
a first line comprising a first fluorescent dye that emits fluorescence in a first color;
a second line comprising a second fluorescent dye that emits fluorescence in a second color;
wherein the back side is covered by a continuous layer of a third fluorescent dye that emits fluorescence in a third color; and
wherein the first, second, and third colors are not the same and are selected from the group consisting of red, green, and blue;
a first projector comprising a first controller operational coupled to a first digital micromirror device (DMD) chip, and first and second ultraviolet light sources optically coupled to the DMD chip, wherein the first and second ultraviolet light sources emit ultraviolet light at distinct wavelengths;
wherein the controller is configured to receive video data comprising a plurality of frames, each frame containing a plurality of pixels, and each pixel having RGB information,
wherein the first controller is programmed to cause the first DMD chip to project ultraviolet light from the first ultraviolet light source onto the first line and to project ultraviolet light from the second ultraviolet light source onto the second line;
wherein the first controller is further programmed to illuminate only portions of the first and second lines in which corresponding pixels in the frame have the first and second color;
a second projector comprising a second controller operational coupled to a second digital micromirror device (DMD) chip, and a third ultraviolet light source optically coupled to the DMD chip, optionally wherein the third ultraviolet light source emits ultraviolet light at the same wavelength as the first or the second ultraviolet light source;
wherein the second controller is configured to receive the video data comprising the plurality of frames, each frame containing the plurality of pixels, and each pixel having RGB information;
wherein the second controller is programmed to cause the DMD chip to project ultraviolet light from the third ultraviolet light source onto the back side of the projection surface;
wherein the second controller is further programmed to illuminate only portions of the back side in which corresponding pixels in the frame have the third color; and
wherein the first and second projectors are configured to operate synchronously.
